(19) United States
(12) Patent Application Publication
(10) Pub. No.: US 2016/0110733 A1
(43) Pub. Date: Apr. 21, 2016

(54) INVENTORY MANAGEMENT SYSTEM

(71) Applicant: Tata Consultancy Services Limited, Mumbai (IN)

(72) Inventors: Soumen RAY, Bangalore (IN); Vandita Bansal, Bangalore (IN); Avneet Saxena, Bangalore (IN)

(21) Appl. No.: 14/856,726

(22) Filed: Sep. 17, 2015

(30) Foreign Application Priority Data
Oct. 17, 2014 (IN) 3325/MUM/2014

(51) Int. Cl. G06Q 30/02

(52) U.S. Cl. CPC G06Q 30/0202

(57) ABSTRACT

Methods and systems for optimizing inventory management by forecasting Stock Keeping Units (SKUs) to be supplied by a consumer packaged goods (CPG) manufacturer to a retailer are provided. A data receiving module receives marketing data, point of sale data, social-media data, and miscellaneous data from one or more data sources. An analysis module, analyzes the social-media data, computes a social-media score. The analysis module generates one or more variables from the marketing data, the point of sale data and the miscellaneous data. The analysis module transforms the one or more variables and the social-media score into one or more transformed variables. A forecasting module forecasts a demand of the SKUs. The forecasting module determines a probability of the OOS and a replenishment time in order to obtain an optimal solution indicating the SKUs to be supplied by the CPG manufacturer to the retailer.

### CROSS-REFERENCE To RELATED APPLICATIONS AND PRIORITY

The present application claims priority from Indian Patent Application No. 3325/MUM/2014, filed on Oct. 17, 2014, the entirety of which is hereby incorporated by reference.

### TECHNICAL FIELD

The present disclosure described herein, in general, relates to systems and methods for managing inventory optimally, and more particularly to systems and methods for managing the inventory by using a Predictive & Optimization modeling approach.

### BACKGROUND

Today, one of the key concerns of manufacturing industries is to keep optimum amount of inventory in order to satisfy demand of a customer. In order to satisfy the demand, sometimes the manufacturing industries might over manufacture so as to fulfill the demand of the customer. Such over manufacturing for satisfying the demand may lead to increased cost of the inventory across supply and distribution networks, which is another area of concern for the manufacturing industries. It has been observed that the demand depends upon the consumption behavior of the customer. Though traditional inventory management methodologies involve both strategic decisions and operational decisions for planning the inventory, traditional inventory management are not operable to monitor the consumption behavior of the customer in order to adapt the changes required to keep the optimum amount of inventory.

Based on the above, it may be understood that, inappropriate planning for keeping the optimum amount of inventory may either lead to excess inventory or Out of Stock (OOS) for a Stock Keeping Unit (SKUs) in the demand. The excess inventory may lead to high working capital and cost for keeping the inventory in warehouses or containers. The OOS, on the other hand, may affect loyalty of the customer towards a specific brand as the customer may prefer to substitute a product P1 with another product P2 of other brand in order to fulfill their necessities. This substitution may lead to loss in total sales of the manufacturer manufacturing the product P1. Thus, the manufacturing industries are faced with the problem of loss in sales when OOS scenario arises at a retailer's place.

Efforts have been made in the past to overcome the problem by estimating sales order, based on sales order data, for the retailer. But only using the sales order data may give rise to the problem of over manufacturing of the inventory or the OOS. This is because if in a period, the retailer ordered more than the actual demand of a product then the retailer may place the order of lesser amount of the inventory pertaining to the product than the actual required amount of the inventory.

### SUMMARY

Before the present systems and methods, are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application. This summary is provided to introduce concepts related to systems and methods for forecasting Stock Keeping Units (SKUs) to be supplied by a consumer packaged goods (CPG) manufacturer to a retailer and the concepts are further described below in the detailed description. This summary is not intended to identify essential features of the disclosure nor is it intended for use in determining or limiting the scope of the disclosure.

In one implementation, a system for optimizing inventory management by forecasting Stock Keeping Units (SKUs) to be supplied by a consumer packaged goods (CPG) manufacturer to a retailer is disclosed. In one aspect, the SKUs to be supplied may be forecasted in order to avoid an out of stock (OOS) at the retailer. In one aspect, the system may comprise a processor and a memory coupled to the processor for executing a plurality of modules present in the memory. The plurality of modules may comprise a data receiving module, an analysis module, and a forecasting module. The data receiving module may receive marketing data, point of sale data, social-media data, and miscellaneous data from one or more data sources. In one aspect, the marketing data, the point of sale data and the social-media data may be associated with the SKUs. The analysis module may analyze the social-media data to compute a social-media score. The social-media score may be computed based on a weighted average of sentiments present in the social-media data, buzz corresponding to the SKUs, and brand of the SKUs. In one aspect, the social-media score indicates demand of the SKUs. The analysis module may further generate one or more variables from the marketing data, the point of sale data and miscellaneous data based upon a model fit. The analysis module may further transform the one or more variables and the social-media score into one or more transformed variables based on the model fit. The forecasting module may forecast a demand of the SKUs by processing the one or more transformed variables using a Bayesian-Var Model. The forecasting module may further determine a probability of the OOS and a replenishment time based on a count of the SKUs. In one aspect, the probability of the OOS and the replenishment time may be associated to the SKUs. The forecasting module may further process the count and a plurality of constraints using a Mixed Integer Linear Programming (MILP) model in order to obtain an optimal solution indicating the SKUs to be supplied by the CPG manufacturer to the retailer. In one aspect, the plurality of constraints may be associated with service level agreement between the CPG manufacturer and the retailer.

In another implementation, a method for optimizing inventory management by forecasting Stock Keeping Units (SKUs) to be supplied by a consumer packaged goods (CPG) manufacturer to a retailer. In one aspect, the SKUs to be supplied may be forecasted in order to avoid an out of stock (OOS) at the retailer. In one aspect, marketing data, point of sale data, social-media data, and miscellaneous data may be received from one or more data sources. In one aspect, the marketing data, the point of sale data and the social-media data may be associated with the SKUs. Upon receiving, the social-media data may be analyzed to compute a social-media score. The social-media score may be computed based on a weighted average of sentiments present in the social-media data, buzz corresponding to the SKUs, and brand of the SKUs. In one aspect, the social-media score may indicate demand of the SKUs. After computing the social-media score, one or more variables may be generated from the marketing data, the point of sale data and miscellaneous data based upon a model fit. Based on the generation of the marketing data, the point of sale data and the miscellaneous data. Upon generating the one or more variables, the one or more variables and the social-media score may be transformed into one or more transformed variables based on the model fit. Subsequent to the transformation, a demand of the SKUs may be forecasted by processing the one or more transformed variables using a Bayesian-Var Model. Upon forecasting the demand of the SKUs, a probability of the OOS and a replenishment time may be determined based on a count of the SKUs. In one aspect, the probability of the OOS and the replenishment time may be associated to the SKUs. Subsequent to the determination of the probability, the count and a plurality of constraints may be processed by using a Mixed Integer Linear Programming (MILP) model in order to obtain an optimal solution indicating the SKUs to be supplied by the CPG manufacturer to the retailer. In one aspect, the plurality of constraints may be associated with service level agreement between the CPG manufacturer and the retailer. In one aspect, the aforementioned method for forecasting SKUs to be supplied by the CPG manufacturer to the retailer is performed by a processor using programmed instructions stored in a memory.

In yet another implementation, non-transitory computer readable medium embodying a program executable in a computing device for optimizing inventory management by forecasting Stock Keeping Units (SKUs) to be supplied by a consumer packaged goods (CPG) manufacturer to a retailer is disclosed. The program may comprise a program code for receiving marketing data, point of sale data, social-media data, and miscellaneous data from one or more data sources. In one aspect, the marketing data, the point of sale data and the social-media data may be associated with the SKUs. The program may further comprise a program code for analyzing the social-media data to compute a social-media score. The social-media score may be computed based on a weighted average of sentiments present in the social-media data, buzz corresponding to the SKUs, and brand of the SKUs. In one aspect, the social-media score may indicate demand of the SKUs. The program may further comprise a program code for generating one or more variables from the marketing data, the point of sale data and the miscellaneous data based upon a model fit. The program may further comprise a program code for transforming the one or more variables and the social-media score into one or more transformed variables based on the model fit. The program may further comprise a program code for forecasting a demand of the SKUs by processing the one or more transformed variables using a Bayesian-Var Model. The program may further comprise a program code for determining a probability of the OOS and a replenishment time based on a count of the SKUs. In one aspect, the probability of the OOS and the replenishment time may be associated to the SKUs. The program may further comprise a program code for processing the count and a plurality of constraints using a Mixed Integer Linear Programming (MILP) model in order to obtain an optimal solution indicating the SKUs to be supplied by the CPG manufacturer to the retailer. The plurality of constraints may be associated with service level agreement between the CPG manufacturer and the retailer.

### BRIEF DESCRIPTION OF THE DRAWINGS

The foregoing detailed description of embodiments is better understood when read in conjunction with the appended drawings. For the purpose of illustrating the disclosure, there is shown in the present document example constructions of the disclosure; however, the disclosure is not limited to the specific methods and apparatus disclosed in the document and the drawings.

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for forecasting Stock Keeping Units (SKUs) to be supplied by a consumer packaged goods (CPG) manufacturer to a retailer is shown, in accordance with an embodiment of the present disclosure.

FIG. 2 illustrates the system, in accordance with an embodiment of the present disclosure.

FIGS. 3 and 4 illustrate a method for forecasting SKUs to be supplied by the CPG manufacturer to the retailer, in accordance with an embodiment of the present disclosure.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the exemplary, systems and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

Systems and methods for optimizing inventory management by forecasting Stock Keeping Units (SKUs) to be supplied by a consumer packaged goods (CPG) manufacturer to a retailer are described. In order to forecast, it is important to account for all the factors that may affect the sales of the retailer. It may be understood that objective of the retailer and the CPG manufacturer may be different. This is because the intent of the retailer would always to optimize replenishment cost due to the fact that consumers might switch between brands due to in Out of Stock (OOS) scenarios. The CPG manufacturer, on the other hand, supplies the SKUs to the retailer based on order placed by the retailer for a SKUS. Thus, the CPG manufacturer manufactures the SKUs based on assumption that the retailer replenishes stock pertaining to the SKUS at most optimum level. In some situation, such inappropriate planning to meet the objectives of the retailer and the CPG manufacturer may either lead to excess inventory or the OOS for the SKUS in demand.

The present system and the method facilitate the CPG manufacturer to forecast the optimized prediction of the sales pertaining to each SKUS in order to avoid the excess inventory. The present system and the method further facilitate to determine probability of the OOS thereby determining replenishment interval for the SKUs to be kept on shelf of the retailer. In order to avoid the excess inventory and the OOS, marketing data, point of sale data, social-media data, and miscellaneous data may be received from one or more data sources. In one aspect, the marketing data, the point of sale data and the social-media data may be associated with the SKUs. Example of the marketing data may include, but not limited to, advertisement campaigns, print advertisement campaigns, radio advertisement campaigns, store promotion information, and store banner. Example of the point of sale data may include, but not limited to, dollar sale of a product, price at which the product was sold at different time intervals, dollar sale of a category of products, percentage share of the category, and weekly sale quantity. Example of the social-media data may include, but not limited to, comments, posts, blogs, and information published in forums. Example of the miscellaneous data may include, but not limited to, unemployment index, GDP, disposable income, consumer price index, competitor market share, competitor promotion, competitor product details, holiday calendar, and percentage of distribution.

In one aspect, the social-media data is analyzed to compute a social-media score. It may be understood that the social-media data may be received from one or more servers corresponding to one or more social-media websites. Examples of the one or more social-media websites may include, but not limited to, Facebook®, Twitter®, and LinkedIn®. In one aspect, the social-media score indicates demand of the SKUs. The social-media score may be computed based on a weighted average of sentiments present in the social-media data, buzz corresponding to the SKUs, and brand of the SKUs. The sentiments may be positive sentiment, negative Sentiment or neutral sentiment towards the brand. The buzz around the brand comprises number of posts, number of comments, number of tweets, number of videos associated with the brand watched either on social networking or televisions. Such information may facilitate to capture the effect of the social media on the sales of the SKUs.

Subsequent to the analysis, one or more variables may be generated from the marketing data, the point of sale data and the miscellaneous data and then transforming the one or more variables and the social-media score into one or more transformed variables to create adstocks information. The adstocks information indicates impact of the one or more social-media websites on the sales of the SKUs. In one aspect, the one or more variables may be transformed based on one or more models. The one or more models may include, but not limited to, a simple decay model, an exponential transformation model, a gamma transformation model, a lag model, a half life model, and a moving average model. In one aspect, the one or more variables are processed by using the one or more models to select a model of the one or more models. The model selected is used to transform the one or more variables into the one or more transformed variables. In one embodiment, the model having a low mean absolute percentage error (MAPE) is selected amongst the one or more models for transforming the one or more variables.

Subsequent to the transformation, a demand of the SKUs may be forecasted by processing the one or more transformed variables using a Bayesian-Var Model. Upon forecasting the demand, a probability of the OOS and a replenishment time may be determined based on a count of the SKUs. In one aspect, the probability of the OOS and the replenishment time may be associated to the SKUs. The probability of the OOS may be determined by using a formulation. The replenishment time, on the hand, may be determined by using a Mixed Integer Linear Programming (MILP) model. The replenishment time indicates a specific time for ordering new inventories pertaining to the SKUs. In one aspect, the replenishment time may be associated to three kinds of replenishment policies. The three kinds of replenishment policies comprising an Economic Order Quantity (EOQ) policy, Continuous Ordering policy, and a Periodic Ordering policy. It may be understood that a replenishment time policy may be selected based on product characteristic and the demand of the SKUS.

Once the probability of the OOS and the replenishment time are determined, the count and a plurality of constraints may be processed by using the MILP model in order to obtain an optimal solution indicating the SKUs to be supplied by the CPG manufacturer to the retailer. In one aspect, the plurality of constraints may be associated with service level agreement between the CPG manufacturer and the retailer. The plurality of constraints may comprise service level agreement (SLA) parameters, the probability of the OOS, variation in demand of the SKUs, and capacity of the retailer to occupy the SKUs. Thus, in this manner, the aforementioned methodology facilitates the CPG manufacturer to forecast the prediction for sales and the demand of the SKUs in order to avoid the OOS at the retailers' place thereby helping the CPG manufacturer to increase the sales, and avoid loss in sales caused by brand switching.

While aspects of described system and method for forecasting Stock Keeping Units (SKUs) to be supplied by a consumer packaged goods (CPG) manufacturer to a retailer may be implemented in any number of different computing systems, environments, and/or configurations, the embodiments are described in the context of the following exemplary system.

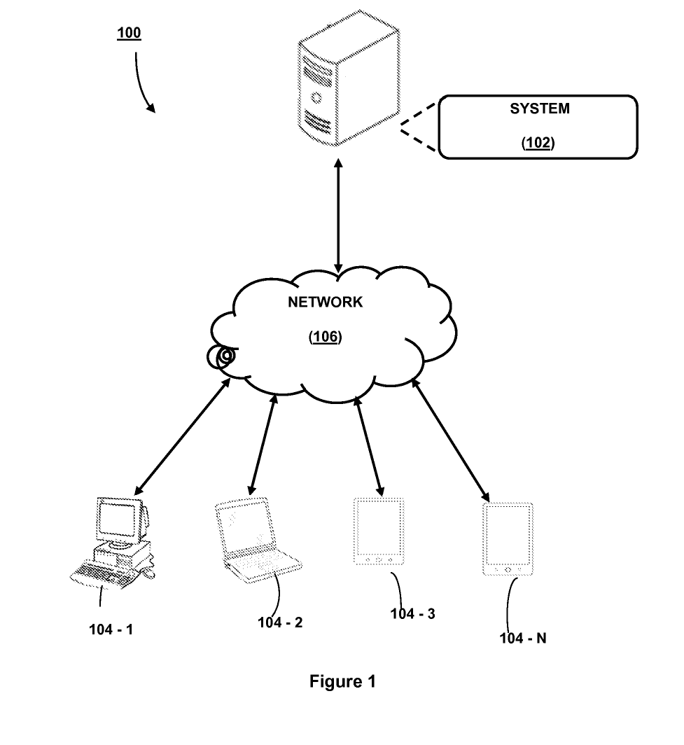

Referring now to FIG. 1, a network implementation 100 of a system, hereinafter referred to as a system 102, for optimizing inventory management by forecasting Stock Keeping Units (SKUs) to be supplied by a consumer packaged goods (CPG) manufacturer to a retailer is disclosed. In one embodiment, the system 102 may receive marketing data, point of sale data, social-media data, and miscellaneous data from one or more data sources. In one aspect, the marketing data, the point of sale data and the social-media data may be associated with the SKUs. The system 102 may further analyze the social-media data to compute a social-media score. The social-media score may be computed based on a weighted average of sentiments present in the social-media data, buzz corresponding to the SKUs, and brand of the SKUs. In one aspect, the social-media score indicates demand of the SKUs. The system 102 may further generate one or more variables from the marketing data, the point of sale data and miscellaneous data based upon a model fit. The system 102 may further transform the one or more variables and the social-media score into one or more transformed variables based on the model fit. The system 102 may further forecast a demand of the SKUs by processing the one or more transformed variables using a Bayesian-Var Model. The system 102 may further determine a probability of the OOS and a replenishment time based on a count of the SKUs. In one aspect, the probability of the OOS and the replenishment time may be associated to the SKUs. The system 102 may further process the count and a plurality of constraints using a Mixed Integer Linear Programming (MILP) model in order to obtain an optimal solution indicating the SKUs to be supplied by the CPG manufacturer to the retailer.

Although the present disclosure is explained considering that the system 102 is implemented on a server, it may be understood that the system 102 may also be implemented in a variety of computing systems, such as a laptop computer, a desktop computer, a notebook, a workstation, a mainframe computer, a server, a network server, a cloud-based computing environment. It will be understood that the system 102 may be accessed by multiple users through one or more user devices 104-1, 104-2 . . . 104-N, collectively referred to as user 104 hereinafter, or applications residing on the user devices 104. In one implementation, the system 102 may comprise the cloud-based computing environment in which a user may operate individual computing systems configured to execute remotely located applications. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

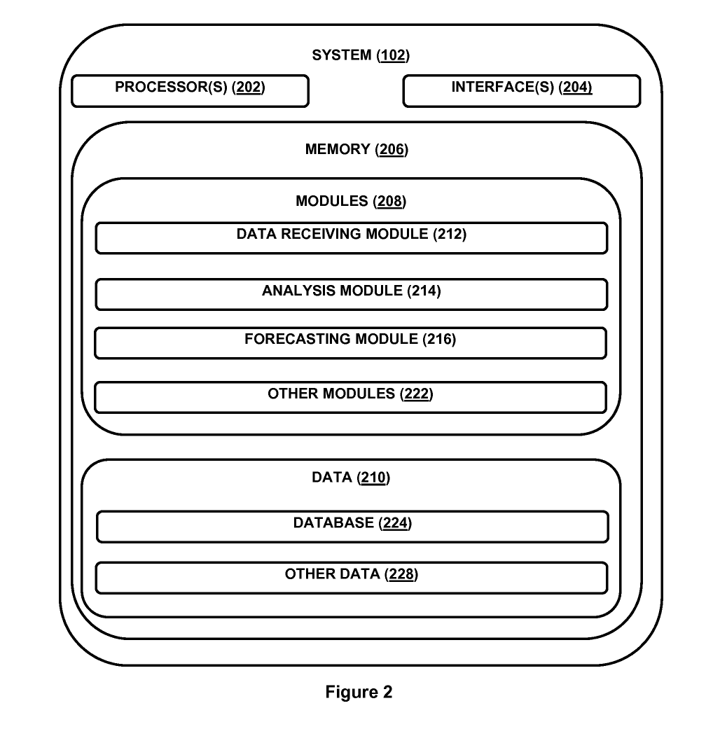

Referring now to FIG. 2, the system 102 is illustrated in accordance with an embodiment of the present disclosure. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with the user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium and computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a data receiving module 212, an analysis module 214, a forecasting module 216 and other modules 218. The other modules 218 may include programs or coded instructions that supplement applications and functions of the system 102. The modules 208 described herein may be implemented as software modules that may be executed in the cloud-based computing environment of the system 102.

The data 210, amongst other things, serves as a repository for storing data processed, received, and generated by one or more of the modules 208. The data 210 may also include a database 220, and other data 222. The other data 222 may include data generated as a result of the execution of one or more modules in the other modules 218.

In one implementation, at first, a user may use the client devices 104 to access the system 102 via the I/O interface 204. The user may register themselves using the I/O interface 204 in order to use the system 102. In one aspect, the user may accesses the I/O interface 204 of the system 102 for forecasting Stock Keeping Units (SKUs) to be supplied by a consumer packaged goods (CPG) manufacturer to a retailer. In one aspect, the SKUs to be supplied may be forecasted in order to avoid an out of stock (OOS) at the retailer. In order to forecast the Stock Keeping Units (SKUs), the system 102 may employ the plurality of modules i.e. the data receiving module 212, the analysis module 214, and the forecasting module 216. The detailed working of the plurality of modules is described below.

Further referring to FIG. 2 in order to forecast the SKUs, initially, the data receiving module 212 receives marketing data, point of sale data, social-media data, and miscellaneous data from one or more data sources. In one aspect, the marketing data, the point of sale data and the social-media data may be associated with the SKUs. Example of the marketing data may include, but not limited to, advertisement campaigns, print advertisement campaigns, radio advertisement campaigns, store promotion information, and store banner. Example of the point of sale data may include, but not limited to, dollar sale of a product, price at which the product was sold at different time intervals, dollar sale of a category of products, percentage share of the category, and weekly sale quantity. Example of the social-media data may include, but not limited to, comments, posts, blogs, and information published in forums. Example of the miscellaneous data may include, but not limited to, unemployment index, GDP, disposable income, consumer price index, competitor market share, competitor promotion, competitor product details, holiday calendar, and percentage of distribution.

After receiving the marketing data, the point of sale data and the social-media data, the analysis module 214 analyzes the social-media data to compute a social-media score. In one aspect, the social-media score may be computed based on a weighted average of sentiments present in the social-media data, buzz corresponding to the SKUs, and buzz corresponding to brand of the SKUs. In one embodiment, the analysis module 214 computes the social-media score by retrieving the social-media data associated to one or more users. The social-media data may be retrieved from one or more social networking servers, corresponding to one or more social networking websites, based on one or more keywords associated to the SKUs. Examples of the social-media data retrieved from the one or more social networking websites may include, but not limited to, Facebook®, Twitter®, and LinkedIn®.

In one aspect, the social-media data may be retrieved is in an unstructured format. In order to process the social-media data, the social-media data may be transformed into a structured format using an Extract, Transform, and Load (ETL) function. Upon transforming the social-media data, the sentiments pertaining to the SKUs may be determined. In one aspect, the sentiments may be associated to the one or more users. In one embodiment, the analysis module 214 analyzes each word the social-media data published by the user on one or more social networking websites. In one embodiment each word may be analyzed by using one of a Natural Language Processing (NLP), a Text analysis technique and a Computational Linguistics to identify and extract subjective information present in social-media data.

In another embodiment, the sentiments may be determined by using Naïve Bayes Algorithm. In one aspect, the sentiments may either be a positive sentiment or a negative sentiment towards the brand. Upon determining the sentiments, the analysis module 214 may further analyzes the buzz corresponding to the SKUs and the buzz corresponding to brand of the SKUs. In one aspect, the buzz indicates a visibility of the brand that may be determined based on number of post, number of comments, number of tweets, and number of videos associated with the brand. It may be understood that the number of post, number of comments, and number of tweets may be posted on at least one of a social networking website whereas the number of videos may be published on YouTube®.

The sentiments present in the social-media data, buzz corresponding to the SKUs, and brand of the SKUs are statistically processes to compute the social-media score using the weighted average method. Thus, in this manner, the analysis module 214 computes the social-media score for the social-media data posted by the one or more users on the social networking website.

In order to understand the functioning of the analysis module 214, consider an example of a ‘Samsung® mobile smart phone’ where the analysis module 214 computes the social-media score for a plurality of posts are associated to the ‘Samsung® mobile smart phone’. In order to compute the social-media score, the data receiving module 212 receives the social-media data from ‘500 users’. The social-media data is captured from Facebook®, Twitter®, LinkedIn® and YouTube®. Since the social-media data present on Facebook®, Twitter®, LinkedIn® and YouTube® are in the unstructured format, an Extract, Transform, and Load (ETL) function is used to transform the social-media data into the structured format. Upon transformation, the social-media is analyzed by using the Naïve Bayes Algorithm to determine information pertaining to a plurality of parameters.

The plurality of parameters comprises number of comments, number of posts, Likes, number of tweets, advertisement, very positive sentiment, viewership on YouTube®, positive sentiment, negative sentiment, very negative sentiment, and neutral sentiment. The information pertaining to the plurality parameters comprises total number of comments received in one week, total number of posts related to the brand in one week, total number of likes of the brand in one week, total number of tweets for the brand in one week, total number of videos/advertisement of brands viewed on YouTube® in one week, percentage of ‘Very Positive’ sentiment for the brand in one week, percentage of ‘Positive’ sentiment for the brand in one week, percentage of ‘Negative’ sentiment for the brand in one week, percentage of ‘Very Negative’ sentiment for the brand in one week, and percentage of ‘Neutral’ sentiment for the brand in one week respectively.

Upon receiving the information corresponding to each of the plurality of parameters, it is observed that ‘320 users’ have shown ‘Negative sentiments’ whereas ‘180 users’ have shown ‘Positive sentiments’ towards the ‘Samsung® mobile smart phone’. In other words, ‘65% users’ indicated non-interest in buying the ‘Samsung® mobile smart phone’ whereas ‘35% users’ indicated interest in buying the ‘Samsung® mobile smart phone’. Thus, based on information corresponding to each of the plurality of parameters, the social-media score is computed for the social-media posted by the ‘500 users’ for the ‘Samsung® mobile smart phone’. In one aspect, 320 users' with ‘Negative sentiments’ and ‘180 users’ with ‘Positive sentiments’ towards the ‘Samsung® mobile smart phone’ indicates the demand of the SKUs (i.e. ‘Samsung® mobile smart phone’)s.

Subsequent to the computation of the social-media score, one or more variables may be generated from the marketing data, the point of sale data and the miscellaneous data. In one aspect, the one or more variables may be created from the marketing data based on a model fit. The one or more several variables are like ACV (All Commodity Value) for display, banner and other activities.

Upon generating the one or more variables and the social-media score, the one or more variables may be transformed into one or more transformed variables. It may be understood that the marketing data and the point of sale data may not be used directly for forecasting. In order to use the marketing data and the point of sale data, the marketing data and the point of sale data are transformed into the one or more transformed variables. In one example, the one or more variables are transformed to create adstocks information. The adstocks information indicates impact of the one or more social-media websites on the sales of the SKUs. In one aspect, the adstocks information is computed by using each of one or more models. The one or more models may include, but not limited to, a simple decay model, an exponential transformation model, a gamma transformation model, a lag model, a half life model, and a moving average model.

In one example, the simple decay model computes the adstocks information using a formula i.e.

Adstockₜ=a*Adstockₜ₋₁+(1−a)*GRPₜ (1)

where 0<a<1 and ‘a’ indicates a decay factor, and wherein GRP is Gross rating point indicates size of an advertising campaign.

In another example, the adstocks information may be computed by the exponential transformation model. The exponential transformation model uses a probability density function (pdf). The pdf comprises

$$f ( x ; λ ) = \{ \begin{matrix}λ {e}^{- λ x} , & x \geq 0 , \\ 0 , & x < 0.\end{matrix} \qquad ( 2 )$$

where λ indicates a rate parameter.

In yet another example, the adstocks information may be computed by the gamma transformation model. It may be observed that sometimes the user might take much longer time making a decision. In such scenarios, the gamma transformation model may facilitate to compute the adstocks information by using

$$f ( x ; k ; θ ) = \frac{1}{{θ}^{k}} \frac{1}{Γ ( k )} {x}^{k - 1} {e}^{- \frac{x}{θ}} \\ for \\ x \geq 0 \\ and \\ k , θ > 0 \qquad ( 3 )$$

where k, θ indicate rate parameters.

Upon computing the adstocks information by using each of the one or more models, a model is selected amongst the one or more models. In one aspect, the model having a low mean absolute percentage error (MAPE) amongst the one or more models may be selected for transforming the one or more variables and thereby using the one or more transformed variables for further processing.

Subsequent to the transformation of the one or more variables, the forecasting module 216 forecasts a demand of the SKUs by processing the one or more transformed variables using a Bayesian-Var Model. Upon forecasting the demand of the SKUs, the forecasting module 216 further determines a probability of the OOS and a replenishment time based on a count s, the probability of the OOS may be determined based on a formula i.e.

z=(x−m)/s (4)

where ‘z’ indicates standard normal distribution of current level of the stock, ‘x’ indicates the current level of the stock, ‘m’ indicates mean of sales for particular week, and ‘s’ indicates standard deviation. For example, in order to determine the probability of the OOS, consider the current level of the stock is 20 units, the mean of sales for particular week is 15, and the standard deviation is 6.

In one aspect, equation (4) is used to determine the standard normal distribution (z)

z=(20−15)/6=0.83 (5)

It may be understood from the normal distribution table the probability value is 0.2967 at 0.03 percent significance level. Therefore, the probability of the OOS is calculate as under

P(z>0.83)=0.5−P(0<z<0.83) (6)

0.5 −0.2967=0.2033 (7)

Hence, the probability of the OOS P(x>20) is 0.2033.

The replenishment time, on the other hand, may be determined by using a Mixed Integer Linear Programming (MILP) model. The replenishment time indicates a specific time for ordering new inventories pertaining to the SKUs. In one aspect, the replenishment time may be associated to three kinds of replenishment policies. The three kinds of replenishment policies comprising an Economic Order Quantity (EOQ) policy, Continuous Ordering policy, and a Periodic Ordering policy. It may be understood that a replenishment time policy may be selected based on product characteristic and the demand of the SKUS. In one embodiment, the replenishment time determined by using the EOQ policy is:

$$EOQ = \sqrt{\frac{2 * D * T * OC}{HC}} \qquad ( 6 )$$

Where ‘D’ is the average demand of customer per day, ‘T’ represents time periods, ‘OC’ represents ordering cost, and ‘HC’ represents handling cost. In one aspect, the MILP model is based on a Branch and bond method. The Branch and bond method model works on continuous ordering on a fixed order quantity. It may be understood that whenever the inventory level reaches a predetermined safety level a trigger for the replenishment of the SKUs is released.

In another embodiment, the system 102 may also determines cost information related one or more cost parameters, pertaining to the SKUs, based on the probability of the OOS and the replenishment time. The one or more cost parameters may include, but not limited to, Ordering Cost (OC), Purchase Cost (PC), Holding Cost (HC), Transportation Cost (TC), Inventory Holding Cost (IC), Backlog Cost (BC), and Safety Stock Penalty Cost (SC). In one aspect, the cost information (z) may be determined by using a below formula:

z=Σ_{z}^{T=}₁Zₚ×OC+Σₜ^{T}=₁Qₚ×PC+Σₜ^{T×}₁lₜ ×HC+B×Σₜ^{T}=tBₜ (7)

The forecasting module 216, upon determining the probability of the OOS, the replenishment time, and the cost information, execute a plurality of scenarios based on a plurality of constrains and the count of the SKUs determined. The plurality of constrains comprises changing service levels agreement (SLA) terms, the probability of the OOS, and the cost information, and the demand forecasted by using the MILP models. In one implementation, the plurality of scenarios is executed in order to obtain an optimal solution indicating the SKUs to be supplied by the CPG manufacturer to the retailer. Upon executing the plurality of scenarios, a scenario may be selected that facilitates to obtain an optimal solution indicating the SKUs to be supplied by the CPG manufacturer to the retailer in compliance with service level agreement between the CPG manufacturer and the retailer. In other words, the scenario is implemented that facilitates to minimize the Out of Stock (OOS) scenario and minimize the cost to keep the inventory in order to satisfy the customer's needs.

Thus, in this manner, the aforementioned method facilitates to forecast the Stock Keeping Units (SKUs) to be supplied by the consumer packaged goods (CPG) manufacturer to the retailer in a manner such it facilitates to avoid an out of stock (OOS) at the retailer, reduce the inventory levels thereby the cost (such as Ordering Cost (OC), Purchase Cost (PC), Holding Cost (HC), Transportation Cost (TC)) across the supply and distribution networks.

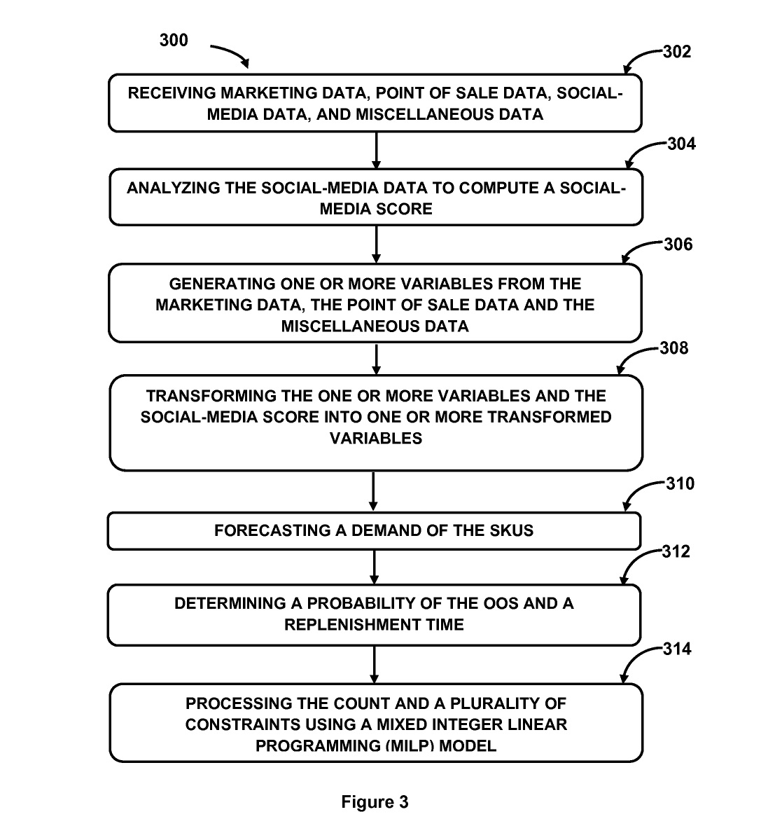

Referring now to FIG. 3, a method 300 for optimizing inventory management by forecasting Stock Keeping Units (SKUs) to be supplied by a consumer packaged goods (CPG) manufacturer to a retailer is shown, in accordance with an embodiment of the present disclosure. The method 300 may be described in the general context of computer executable instructions. Generally, computer executable instructions can include routines, programs, objects, components, data structures, procedures, modules, functions, etc., that perform particular functions or implement particular abstract data types. The method 300 may be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the disclosure described herein. Furthermore, the method can be implemented in any suitable hardware, software, firmware, or combination thereof. However, for ease of explanation, in the embodiments described below, the method 300 may be considered to be implemented in the above described in the system 102.

At block 302, data, point of sale data, social-media data, and miscellaneous data may be received from one or more data sources. In one aspect, the marketing data, the point of sale data and the social-media data may be associated with the SKUs. In one implementation, the data, point of sale data, social-media data, and miscellaneous data may be received by the data receiving module 212.

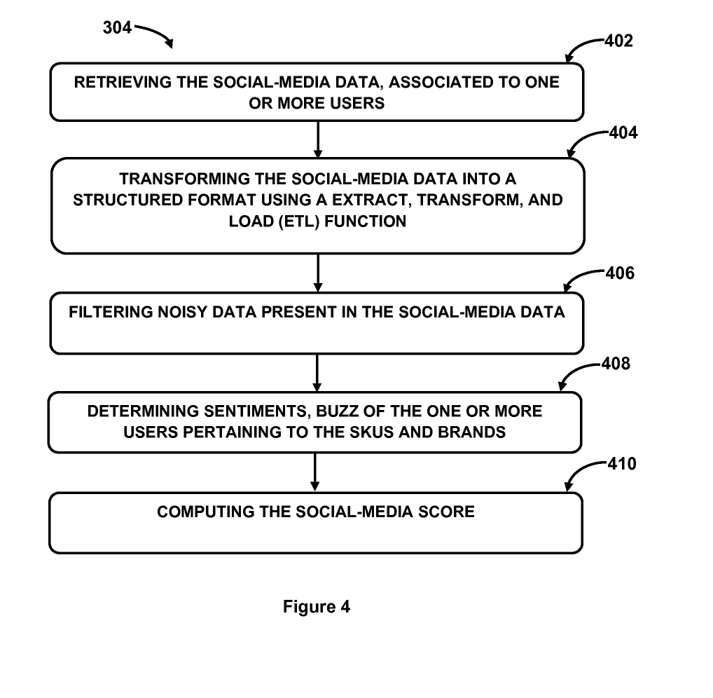

At block 304, the social-media data may be analyzed to compute a social-media score. In one aspect, the social-media score may be computed based on a weighted average of sentiments present in the social-media data, buzz corresponding to the SKUs, and brand of the SKUs. In one aspect, the social-media score indicates demand of the SKUs. In one implementation, the social-media data may be analyzed by the analysis module 214. Further, the block 304 may be explained in greater detail referring FIG. 4.

At block 306, one or more variables may be generated from the marketing data, the point of sale data and the miscellaneous data based upon . . . . In one implementation, one or more variables may be generated by the analysis module 214.

At block 308, the one or more variables and the social-media score may be transformed into one or more transformed variables based on a model fit. In one implementation, the one or more variables and the social-media score may be transformed by the analysis module 214.

At block 310, a demand of the SKUs may be forecasted by processing the one or more transformed variables using a Bayesian-Var Model. In one implementation, the demand may be forecasted by the forecasting module 216.

At block 312, a probability of the OOS and a replenishment time may be determined based on a count of the SKUs. In one aspect, the probability of the OOS and the replenishment time may be associated to the SKUs. In one implementation, the probability of the OOS and the replenishment time may be determined by the forecasting module 216.

At block 314, the count and a plurality of constraints may be processed by using a Mixed Integer Linear Programming (MILP) model in order to obtain an optimal solution indicating the SKUs to be supplied by the CPG manufacturer to the retailer. In one aspect, the plurality of constraints may be associated with service level agreement between the CPG manufacturer and the retailer. In one implementation, the count and the plurality of constraints may be processed by the forecasting module 216.

Referring now to FIG. 4, a method 304 for computing the social-media score upon analyzing the social-media data is shown, in accordance with an embodiment of the present subject matter.

At block 402, the social-media data, associated to one or more users may be retrieved from one or more social networking servers. In one aspect, the social-media data may be retrieved based on one or more keywords associated to the SKUs. In one aspect, the social-media data may be retrieved is in unstructured format. In one implementation, the social-media data may be retrieved by the analysis module 214.

At block 404, the social-media data may be transformed into a structured format using an Extract, Transform, and Load (ETL) function. In one implementation, the social-media data may be transformed by the analysis module 214.

At block 406, noisy data present in the social-media data may be filtered by using one or more noise removing filtering techniques. In one implementation, the noisy data may be filtered by the analysis module 214.

At block 408, sentiments, buzz of the one or more users pertaining to the SKUs, and brand may be determined by analyzing the social-media data. In one aspect, the sentiments, the buzz, and the brand may be determined by using Naïve Bayes Algorithm. In one implementation, the sentiments may be determined by the analysis module 214.

At block 410, the social-media score may be computed based on the sentiments by using the weighted average method. In one implementation, the social-media score may be computed by the analysis module 214.

Although implementations for methods and systems for forecasting Stock Keeping Units (SKUs) to be supplied by a consumer packaged goods (CPG) manufacturer to a retailer have been described in language specific to structural features and/or methods, it is to be understood that the appended claims are not necessarily limited to the specific features or methods described. Rather, the specific features and methods are disclosed as examples of implementations for forecasting the SKUs to be supplied by the CPG manufacturer to the retailer.

Exemplary embodiments discussed above may provide certain advantages. Though not required to practice aspects of the disclosure, these advantages may include those provided by the following features.

Some embodiments enable a system and a method to forecast more accurate prediction of sales when compared to the traditional approaches for forecasting.

Some embodiments enable the system and the method to determine a probability of Out of Stock (OOS) scenarios for a retailer thereby defining a replenishment plan in order to avoid the OOS scenarios.

Some embodiments enable the system and the method to forecast the future demand and the OOS scenarios thereby facilitating a CPG manufacturer to increase the sales and avoid loss in sales caused by brand switching.

Some embodiments enable the system and the method to facilitate the CPG manufacturer to decide optimum level of inventory that should be kept at the retailer's place in order to satisfy the demand of the customer.

Some embodiments enable the system and the method to reduce working capital such as holding cost, transportation cost, ordering cost and procurement costs by optimizing the level of the inventory.

Some embodiments enable the system of the instant disclosure to optimize inventory management by forecasting more accurate SKUs with improved system performance resulting from the method of the instant disclosure.

What is claimed is:

1. A method for optimizing inventory management by forecasting Stock Keeping Units (SKUs) to be supplied by a consumer packaged goods (CPG) manufacturer to a retailer, wherein the SKUs to be supplied are forecasted in order to avoid an out of stock (OOS) at the retailer, the method comprising:
receiving, by a processor, marketing data, point of sale data, social-media data, and miscellaneous data from one or more data sources, wherein the marketing data, the point of sale data and the social-media data are associated with the SKUs;
analyzing, by the processor, the social-media data to compute a social-media score, wherein the social-media score is computed based on a weighted average of sentiments present in the social-media data, buzz corresponding to the SKUs, and brand of the SKUs, and wherein the social-media score indicates demand of the SKUs;
generating, by the processor, one or more variables from the marketing data, the point of sale data and the miscellaneous data based upon a model fit;
transforming, by the processor, the one or more variables and the social-media score into one or more transformed variables based on the model fit;
forecasting, by the processor, a demand of the SKUs by processing the one or more transformed variables using a Bayesian-Var Model;
determining, by the processor, a probability of the OOS and a replenishment time based on a count of the SKUs, wherein the probability of the OOS and the replenishment time are associated to the SKUs; and
processing, by the processor, the count and a plurality of constraints using a Mixed Integer Linear Programming (MILP) model in order to obtain an optimal solution indicating the SKUs to be supplied by the CPG manufacturer to the retailer, wherein the plurality of constraints is associated with service level agreement between the CPG manufacturer and the retailer.

2. The method of claim 1, wherein the marketing data comprises advertisement campaigns, print advertisement campaigns, radio advertisement campaigns, store promotion information, and store banner.

3. The method of claim 1, wherein the point of sale data comprises dollar sale of a product, price at which the product was sold at different time intervals, dollar sale of a category of products, percentage share of the category, and weekly sale quantity.

4. The method of claim 1, wherein the social-media data comprises comments, posts, blogs, and information published in forums.

5. The method of claim 1, wherein the miscellaneous data comprises unemployment index, GDP, disposable income, consumer price index, competitor market share, competitor promotion, competitor product details, holiday calendar, and percentage of distribution.

6. The method of claim 1, wherein the social-media score is computed by
retrieving the social-media data, associated to one or more users, from one or more social networking servers based on one or more keywords associated to the SKUs, wherein the social-media data is retrieved is in unstructured format;
transforming the social-media data into a structured format using an Extract, Transform, and Load (ETL) function;
filtering noisy data present in the social-media data using one or more noise removing filtering techniques;
determining sentiments of the one or more users pertaining to SKUS, the buzz of the SKUS and the brand of the SKUS by analyzing the social-media data; and
computing the social-media score, based on the determination of the sentiments, the buzz, and the brand, by using the weighted average method.

7. The method of claim 1, wherein the probability of the OOS is determined by using a formula, and wherein the formula is z=(x−m)/s, and wherein x indicates current level of stock, m indicates mean of sales for particular week, s indicates standard deviation, and z standard normal distribution of the current level of the stock.

8. The method of claim 1, wherein the replenishment quantity, and safety stock is determined by Mixed Integer Linear Programming (MILP)

9. The method of claim 1, wherein the plurality of constraints comprises service level agreement (SLA) parameters, the probability of the OOS, variation in demand of the SKUs, and capacity of the retailer to occupy the SKUs.

10. A system for optimizing inventory management by forecasting Stock Keeping Units (SKUs) to be supplied by a consumer packaged goods (CPG) manufacturer to a retailer, wherein the SKUs to be supplied are forecasted in order to avoid an out of stock (OOS) at the retailer, the system comprising:
a processor; and
a memory coupled to the processor, wherein the processor is capable of executing a plurality of modules stored in the memory, and wherein the plurality of module comprising:
a data receiving module for receiving marketing data, point of sale data, social-media data, and miscellaneous data from one or more data sources, wherein the marketing data, the point of sale data and the social-media data are associated with the SKUs;
an analysis module for
analyzing the social-media data to compute a social-media score, wherein the social-media score is computed based on a weighted average of sentiments present in the social-media data, buzz corresponding to the SKUs, and brand of the SKUs, and wherein the social-media score indicates demand of the SKUs;
generating one or more variables from the marketing data, the point of sale data and the miscellaneous data based upon a model fit; and
transforming the one or more variables and the social-media score into one or more transformed variables based on the model fit;
a forecasting module for
forecasting a demand of the SKUs by processing the one or more transformed variables using a Bayesian-Var Model;
determining a probability of the OOS and a replenishment time based on a count of the SKUs, wherein the probability of the OOS and the replenishment time are associated to the SKUs; and
processing the count and a plurality of constraints using a Mixed Integer Linear Programming (MILP) model in order to obtain an optimal solution indicating the SKUs to be supplied by the CPG manufacturer to the retailer, wherein the plurality of constraints is associated with service level agreement between the CPG manufacturer and the retailer.

11. A non-transitory computer readable medium embodying a program executable in a computing device for optimizing inventory management by forecasting Stock Keeping Units (SKUs) to be supplied by a consumer packaged goods (CPG) manufacturer to a retailer, wherein the SKUs to be supplied are forecasted in order to avoid an out of stock (OOS) at the retailer, the program comprising a program code:
a program code for receiving marketing data, point of sale data, social-media data, and miscellaneous data from one or more data sources, wherein the marketing data, the point of sale data and the social-media data are associated with the SKUs;
a program code for analyzing the social-media data to compute a social-media score, wherein the social-media score is computed based on a weighted average of sentiments present in the social-media data, buzz corresponding to the SKUs, and brand of the SKUs, and wherein the social-media score indicates demand of the SKUs;
a program code for generating one or more variables from the marketing data, the point of sale data and the miscellaneous data based upon a model fit;
a program code for transforming the one or more variables and the social-media score into one or more transformed variables based on the model fit;
a program code for forecasting a demand of the SKUs by processing the one or more transformed variables using a Bayesian-Var Model;
a program code for determining a probability of the OOS and a replenishment time based on a count of the SKUs, wherein the probability of the OOS and the replenishment time are associated to the SKUs; and
a program code for processing the count and a plurality of constraints using a Mixed Integer Linear Programming (MILP) model in order to obtain an optimal solution indicating the SKUs to be supplied by the CPG manufacturer to the retailer, wherein the plurality of constraints is associated with service level agreement between the CPG manufacturer and the retailer.
